(19) United States
(12) Patent Application Publication
(10) Pub. No.: US 2013/0146655 A1
(43) Pub. Date: Jun. 13, 2013

(54) CODE FOR ANONYMOUS USER NOTIFICATION

(71) Applicant: Kawaljit Gandhi, San Francisco, CA (US)

(72) Inventor: Kawaljit Gandhi, San Francisco, CA (US)

(21) Appl. No.: 13/807,424

(22) PCT Filed: Jul. 1, 2011
(86) PCT No.: PCT/US11/42835

§ 371 Date: Feb. 13, 2013

Related U.S. Application Data
(60) Provisional application No. 61/360,773, filed on Jul. 1, 2010.

(51) Int. Cl. G06F 17/30

(52) U.S. Cl. CPC G06F 17/30002
USPC 235/375

(57) ABSTRACT

In general, this disclosure describes techniques for identifying property with encoded contact information that allows anonymous communication with the property owner. The owner's contact information may be encoded using a computer-generated image, which may be affixed to the property. A user with a computing device can read the computer-generated image, resulting in initiating communication with the owner, without displaying the owner's contact information. The owner's contact information may be registered with a service that performs the communication with the owner on behalf of the computing device user.

### TECHNICAL FIELD

This disclosure relates to processing computer-readable images by a computing device.

### BACKGROUND

Owners of property often wish to identify their property as belonging to them to be able to relocate the property if misplaced. A property owner may misplace property such as, for example, electronics, books, and the like, and may want his/her misplaced property identified and returned. However, the property owner may not want to place his/her personal information including, for example, name, phone number, address, e-mail address, and contact information on the property, for security and safety concerns.

### SUMMARY

In general, this disclosure describes techniques for providing a first user with the ability to identify his/her property with encoded contact information that allows anonymous communication with the first user. The first user's contact information may be encoded using a computer-generated image, which may be affixed or attached to the first user's property. These techniques allow reading of the computer-generated image by a computing device belonging to a second user, resulting in initiating communication with the first user, without allowing the second user to access to the first user's contact information. The first user's contact information may be registered with a service that performs the communication with the first user on behalf of the second user.

In one example, the disclosure is directed to a method comprising scanning, by a computing device, a computer-readable image associated with one or more tangible objects, to obtain encoded information, wherein the information comprises a reference to contact information associated with a user, and wherein the contact information associated with the user is unavailable to the computing device, decoding the encoded information to obtain the reference, and transmitting, from the computing device to a service provider, an indication of the reference, an indication of the one or more tangible objects, and an indication of the computing device, such that the service provider is capable of using the contact information to communicate with the user regarding the one or more tangible objects.

In another example, the disclosure is directed to a computer-readable storage medium encoded with instructions that, when executed, cause one or more processors of a computing device to perform operations comprising scanning, by the computing device, a computer-readable image associated with one or more tangible objects, to obtain encoded information, wherein the information comprises a reference to contact information associated with a user, and wherein the contact information associated with the user is unavailable to the computing device, decoding the encoded information to obtain the reference, and transmitting, from the computing device to a service provider, an indication of the reference, an indication of the one or more tangible objects, and an indication of the computing device, such that the service provider is capable of using the contact information to communicate with the user regarding the one or more tangible objects.

In another example, the disclosure is directed to a computing device comprising a scanning device operable to scan a computer-readable image associated with one or more tangible objects, to obtain an encoded reference to contact information associated with a user, and wherein the computing device refrains from displaying the contact information associated with the user, one or more processors operable to decode the encoded reference to the contact information to obtain the reference, and a transmitter for transmitting, to a service provider, an indication of the reference to the contact information, an indication of the one or more tangible objects, and an indication of the computing device, such that the service provider is capable of using the contact information to communicate with the user regarding the one or more tangible objects.

In another example, the disclosure is directed to a method comprising receiving from a first computing device, by a service provider, an indication of a reference to contact information associated with a user of a second computing device and an indication of one or more tangible objects, wherein the reference is encoded in a computer-readable image associated with the one or more tangible objects, determining the contact information associated with the user based on the reference, and transmitting, using the contact information, a communication regarding the one or more tangible objects to the second computing device.

The techniques of this disclosure may provide one or more advantages. For example, certain techniques may allow a first person to identify his/her property, so that if the property is misplaced, a second person may be able to communicate with the first user to return the misplaced property. The first person may affix to the property a computer-generated image that is computer-readable by a computing device. The computer-generated image may be generated by a service provider, such that the first person's contact information may not be accessible by the second person, and reading the computer-generated image by the second person's computing device results in sending an indication to the first person, via the service provider.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram illustrating an example system.

FIG. 1B is a block diagram illustrating details of one example of the service provider shown in FIG. 1A.

FIGS. 2A and 2B illustrate example screens of a computing device as a user interacts with the device.

FIG. 3 is a block diagram illustrating further details of one example of the computing device shown in FIGS. 2A and 2B.

FIG. 4 is a flow diagram illustrating a process for anonymous user notification that may be performed by a computing device.

### DETAILED DESCRIPTION

In general, this disclosure describes techniques for providing a user with the ability to identify his/her property (e.g., tangible objects) with encoded contact information that allows anonymous communication with the user. The user's contact information may be encoded using a computer-generated image. The computer-generated image may be affixed or attached to the user's property. The computer-generated image may be computer-readable. These techniques allow reading of the computer-generated image by a computing device, resulting in anonymous communication with the user, without allowing another user, who is operating the computing device, access to the user's contact information. The user's contact information may be registered with a service that performs the communication with the user on behalf of the other user (i.e., the operator of the computing device).

The techniques of this disclosure take advantage of the ability of computing devices to read computer-generated images. For example, most current mobile devices incorporate cameras that may be used to capture an image, such as a computer-generated image. A mobile device may also be capable of utilizing applications that decode the image of the computer-generated image to access the information encoded therein.

In one example, computer-generated images may be barcodes, which are computer-generated images that encode data and are computer-readable. In some examples, an optical scanner may be utilized to read computer-generated images and decode the scanned image to obtain a decoded version of the data, e.g., text, product information, contact information, website address, and the like.

In some examples, barcodes may be linear or 1-dimensional images, which represent data in parallel lines and spacing between the parallel lines. Universal product code (UPC) is one example of linear or 1-dimensional barcodes, and is widely used to track items, usually in stores. The UPC encodes 12 digits as alternating bars and spaces with varying widths. In retail, each digit may have a specific meaning based on location and value, indicating such things as the type of products, country of origin, and price, for example.

In other examples, barcodes may be matrix codes or 2-dimensional images, which represent data in any one of a multitude of shapes such as squares, dots, hexagons, and other geometric patterns. Matrix code or 2-dimensional barcodes are similar to linear or 1-dimensional barcodes, but have more data representation capabilities. PDF417, QR code, and Aztec code are some examples of 2-dimensional barcodes. For example, a PDF417 barcode consists of 3 to 90 rows, each of which is a linear barcode. Another example, an Aztec code is a symbol built on a square grid with a bulls-eye pattern in the center, and data is encoded in concentric square rings around the bulls-eye pattern.

A QR code is a symbol built on a square grid with three corner square patterns that define its position. QR codes are widely used to encode a variety of information, and QR code generation websites are publicly available. Users with a computing device equipped with a camera and a reader application can capture an image of the QR code using the camera and decode it using the reader application. In one example, the QR code may encode a universal resource locator (URL), and upon scanning the QR code, the reader application may decode the code and cause the launching of a browser and redirecting to the encoded URL. In another example, the QR code may encode contact information, such as e-mail address or phone number, and upon scanning the QR code, the reader application may decode the code and launch an appropriate application to utilize the information. For example, the reader application may launch an e-mail application and populate the “TO” field with the encoded e-mail address, or the reader application may give the user the option to make a phone call or send a text message to the encoded phone number. While this disclosure discusses using QR codes, it should be understood that the techniques of this disclosure are applicable to other types of computer-generated images and barcodes. In some examples, the techniques of this disclosure may be applicable to other types of computer-readable signals or devices such as, for example, near field communication (NFC) tags or radio frequency identification (RFID) tag.

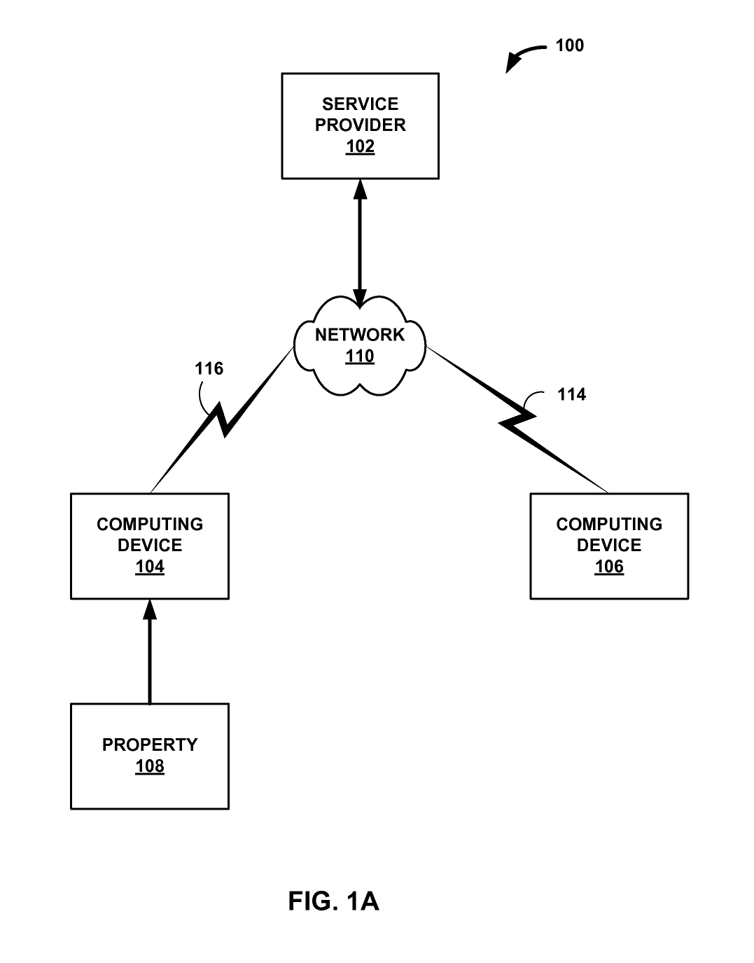

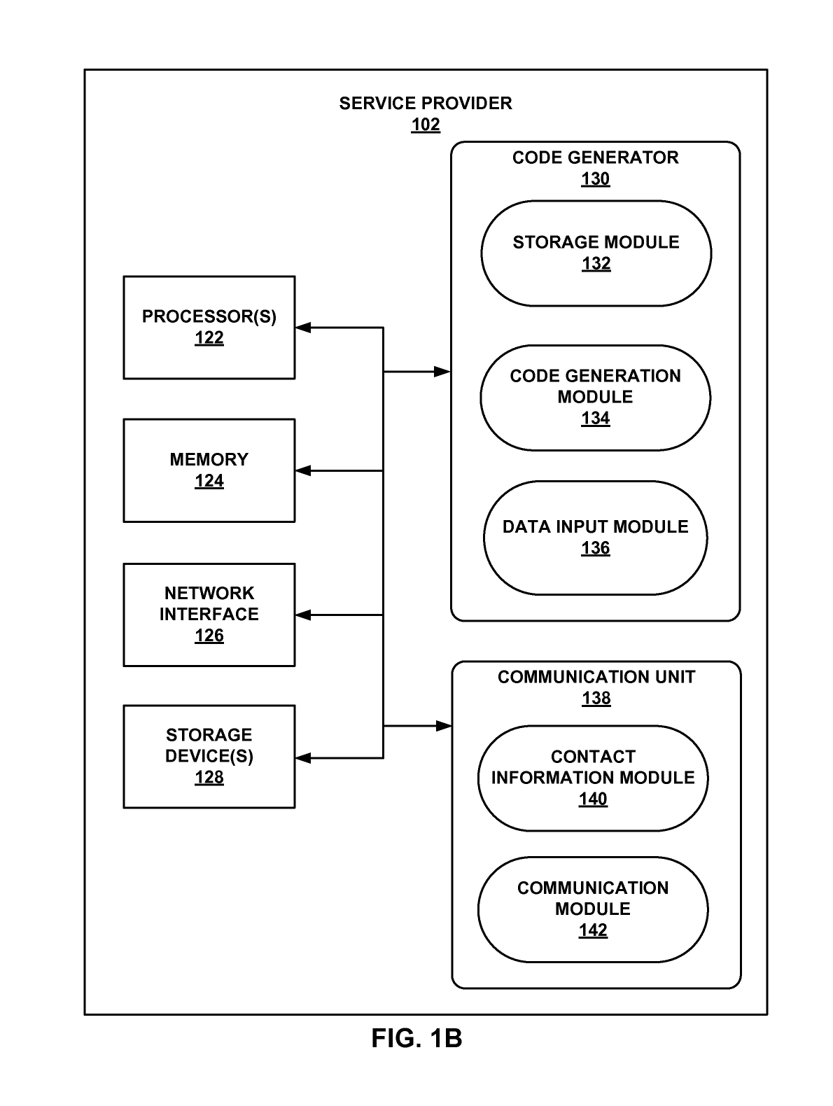

FIG. 1A is a block diagram illustrating an example system. In the example of FIG. 1A, system 100 includes service provider 102, computing devices 104 and 106, property item 108, and network 110. Network 110 allows access and interaction between computing devices and resources, such as service provider 102 or other networking resources (e.g., the Internet). Devices in system 100 may interact via network 110 over network connections, such as network connections 114 and 116.

An owner of property 108 may wish to identify property, e.g., books, electronics, and other tangible objects, such that if the owner misplaces the property, a person who finds the misplaced property can contact the owner to return the misplaced property. However, the owner of the property may not want to place personal information including, for example, name, phone number, address, e-mail address, and the like on the property, for security and safety concerns. Therefore, it may be desirable for the owner to identify property and allow a person who finds the owner's misplaced property to contact the owner anonymously, without actually seeing or having access to the owner's personal information.

In accordance with techniques of this disclosure, a property owner may register contact information (e.g., phone number, e-mail address, and the like), and a preferred method of contact (e.g., phone call, text message, e-mail message, etc.) with a service or application provided by service provider 102. In one example, owner of property 108 may register with service provider 102 online, by visiting a URL associated with service provider 102 and entering the contact and preference information. Service provider 102 may be a dedicated service center or a communications service company, for example. In one example, the service provider may generate a computer-generated image (e.g., a QR code) that encodes an identifier associated with or a reference to the owner's contact information and preferred method of contact. The identifier or reference may allow the service provider to retrieve the owner's contact information and preferred method of contact. In one example, the computer-generated image may encode the owner's preferred method of contact (e.g., text-based communication or voice-based communication). The computer-generated image may encode the owner's contact information indirectly, e.g., using an identifier or reference to the owner's contact information, such that, when the image is read by a device, e.g., computing device 104, the owner's contact information is not readily accessible by the operator of the computing device, but is accessible for contacting the owner without revealing the owner's identity or contact information.

In one example, the computer-generated image may encode information that causes a reader application to launch and initiate a connection with service provider 102. Based on information contained in a message that is communicated to service provider 102, service provider 102 contacts the owner, via owner's computing device 106, according to the registered contact information and preferred method of contact. The owner's contact information may be associated with an identifier specific to the owner, and may be stored in a database of registered owners and their contact information. In one example, the identifier may be encoded in the computer-generated image associated with the owner, and may be utilized by service provider 102 to locate owner's information in the database of owners' contact information. In one example, the identifier may be a masking phone number or e-mail address that does not provide any information about the owner, such that, when the computer-generated image is read by a computing device, the masking phone number or masking e-mail address may appear, and allow communication with owner's computing device 106 through service provider 102, where the masking phone number or masking e-mail address is matched to the owner's phone number or e-mail address.

The owner may place the computer-generated image on his/her property 108. The owner may wish to use different computer-generated images on different types of property. For example, certain types of property may be of more importance to the owner and therefore, he/she may want to know sooner when/if the property is misplaced and may require more urgent method of communication to be notified when they are located, e.g., phone call. Whereas, other types of property may be less important, and recovering them after misplacement may be less urgent, therefore, the owner may utilize a less urgent method of communication to be notified when they are located, e.g., e-mail or text message.

When the owner misplaces his/her property 108, a user who finds the property and wishes to contact and notify the owner regarding the misplaced property may use computing device 104 equipped to read computer-generated images (e.g., a mobile phone, tablet, personal digital assistant (PDA), or the like) to scan the computer-generated image and decode it to initiate contact with the owner of the property via owner's computing device 106 (e.g., mobile phone, PDA, or the like). In one example, the contact with the owner of the property may not be direct, and may go through a service, as described above. In one example, the user's computing device 104 may have an image capture device (e.g., camera) that device 104 can utilize to capture an image of the computer-generated image placed on property 108. The user's computing device 104 may also have a reader application, which launches upon capturing and scanning of the computer-generated image. The reader application may decode the scanned image and determine based on the information contained in the computer-generated image what to do next. In one example, the information encoded in the computer-generated image may be contact information and instructions that cause the computing device 104 to launch a corresponding communication application to contact computing device 106 via service provider 102 with information indicating the scanned computer-generated image. Consequently, service provider 102 may manually or automatically contact the owner of property 108 according to the information provided by the owner at the time of generation of the computer-generated image. In another example, the information encoded in the computer-generated image may be contact information and instructions that cause the computing device 104 to contact the owner directly.

For example, the information encoded in the computer-generated image may include an identifier associated with computing device 106, and service provider 102 may maintain a database of associations between registered computing devices and unique identifiers. The information may also include contact information and/or instructions that computing device 104 may use to communicate a message to service provider 102, along with the identifier. Service provider 102 may look up in the database contact information for computing device 106 based on the identifier, and send a communication to computing device 106.

In another example, the information in the computer-generated image may include masking contact information, such as a masking phone number or a masking e-mail address, which may be generated by service provider 102 as masking contact information for the contact information of the owner of computing device 106. In the example where the computer-generated image may include masking contact information, the user of computing device 104 may be able to retrieve the masking contact information and use a text-based application (e.g., e-mail or SMS) or voice-based application (e.g., phone call) to contact the owner of computing device 106, without having access to the actual contact information. When placing a call or sending a text or e-mail message, for example, the communication may go through service provider 102 and get routed to computing device 106 based on a database that matches the masking contact information to the actual contact information for the owner.

In one example, when the user uses computing device 104 to scan the computer-generated image affixed on property 108, the reader application may launch a screen allowing the user to initiate contact. In one example, when the user initiates contact, the user's computing device 104 may send an automated message or place an automated call to the owner regarding the misplaced property 108. The user who finds property 108 may not see the owner contact information, and may not directly contact the owner. In another example, when the user initiates contact, user's computing device 104 may send a message to computing device 106 or call computing device 106, using masking contact information, as described above, using the service provider 102 as an intermediary. In this example, the user of computing device 104 may provide the owner of computing device 106, who is also the owner of property 108, with information regarding the misplaced property 108.

In one example, if the owner's preferred method of contact is a short message service (SMS) message, the user who finds the property may be prompted to enter a text message regarding the misplaced property. When the user sends the SMS message, the message may be communicated to a central location associated with service provider 102, which subsequently forwards the message on to the owner of property 108.

In another example, the user who finds the property may be prompted to enter a message, which may be then sent to a central location associated with service provider 102, which may subsequently contact the owner using his/her preferred method of communication. In this example, the user may merely send an indication of property 108 to service provider 102, which then formulates an appropriate message (e.g., voice, text, etc.) according to owner's preferences. In either example, the user who finds the property has no access to the owner's contact information. In one example, the communication from user's computing device 104 may include an identifier that service provider 102 may utilize to locate owner's contact information and preferred method of communication in the owner database.

In another example, the communication from the computing device 104 may utilize masking contact information that is useable by service provider 102 to route the communication to the owner using the owner's contact information by matching the masking contact information generated by service provider 102 to the owner's contact information. In this example, the preferred method of contact may be encoded in the computer-generated image and automatically launch the appropriate communication application in computing device 104, without showing the owner's contact information. The user of computing device 104 may then send a communication using the launched communication application to service provider 102, which then forwards the communication to computing device 106. When the owner of property 108 receives a communication on computing device 106, the displayed contact information (e.g., incoming phone call, text message, or e-mail message) may be the masking contact information, such that the contact information associated with computing device 104 from which the communication originated is not available to computing device 106. In this manner, service provider 102 may act as an intermediary that has access to the contact information associated with computing devices communicating with each other through service provider 102, while keeping contact information associated each of the computing devices hidden from the other computing devices with which it communicates.

In one example of this disclosure, the computer-generated image may contain audio data, such as an audio message. In this example, when the user uses computing device 104 to scan the computer-generated image affixed on property 108, the reader application may launch an audio-playing application to play back the audio data. The audio message may be a message recorded by the owner of computing device 106 or a computerized audio message that provides instructions regarding contacting the owner of property 108. In one example, the instructions may provide masking contact information and a method of communication such as, for example, “please call telephone number xxx-xxx-xxxx, to provide information regarding this property.”

FIG. 1B is a block diagram illustrating details of one example of service provider 102 shown in FIG. 1A. FIG. 1B illustrates only one particular example of service provider 102, and many other examples of service providers may be used in other instances, where other service providers may provide more or less services to customers, such as owner of computing device 106 of FIG. 1A. As shown in the example of FIG. 1B, service provider 102 may include one or more processors 122, memory 124, a network interface 126, one or more storage devices 128, code generator 130, and communication module 138. Each of components 122, 124, 126, 128, 130, and 138 may be interconnected via one or more buses for inter-component communications, and may reside in one location or at different locations and connected over a network. Processors 122 may be configured to implement functionality and/or process instructions for execution in accordance with functionalities provided by service provider 102. Processors 122 may be capable of processing instructions stored in memory 124 or instructions stored on storage devices 128.

Memory 124 may be configured to store information while service provider 102 is performing operations. Memory 124 may, in some examples, be described as computer-readable storage medium. In some examples, memory 124 is a temporary memory, meaning that a primary purpose of memory 124 is not long-term storage. Memory 124 may also be described as a volatile memory, meaning that memory 124 does not maintain stored contents when service provider 102 is not in use. Examples of volatile memories include random access memories (RAM), dynamic random access memories (DRAM), static random access memories (SRAM), and other forms of volatile memories known in the art. In some examples, memory 124 may be used to stored program instructions for execution by processors 122. Memory 124 may be used by software or applications operating in connections with functionalities of service provider 102 to temporarily store information during program execution.

Storage devices 128 may also include one or more computer-readable storage media. Storage devices 128 may be configured to store larger amounts of information than memory 124. Storage devices 128 may further be configured for long-term storage of information. In some examples, storage devices 128 may comprise non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Service provider 102 also includes network interface 126. Service provider 102 may utilize network interface 126 to communicate with external devices (e.g., one or more servers, web servers, computing devices 104 and 106) via one or more networks (e.g., the Internet). Any applications or service implemented or provided by service provider 102 (e.g., code generator 130, communication unit 138) may be implemented by, operable by, executed by, and/or be operatively coupled to processors 122, memory 124, network interface 126, and/or storage devices 128.

Code generator 130 may include storage module 132, code generation module 134, and data input module 136. Data input module 136 may control functionality that allows a user, such as owner of property 108, to input information that the user wishes to encode in a computer-generated image. Code generator 130 may utilize code generation module 134 to encode the user information into an appropriate format.

In one example, an owner of property may provide his/her contact information to service provider 102. Data input module 136 may manage receiving the owner contact information and provide it to other modules, such as storage module 132 and code generation module 134. Data input module 136 may receive the owner contact information via network interface 126, which may receive the information input by the user at a location associated with service provider 102 or remotely via a website, for example. Code generation module 134 may utilize the owner contact information to generate a computer-readable image, as discussed above, which the user may affix to his/her property.

Code generation module 134 may encode the owner contact information anonymously, such that a reader capable of reading the computer-generated image may not have access to owner contact information. In one example, code generation module 134 may encode an identifier associated with owner contact information and communication preference that may launch an appropriate communication application when read by a computing device. In another example, code generation module 134 may encode masking contact information associated with owner contact information, where the masking contact information may be a masking phone number or e-mail address that does not indicate the identity of the owner or the owner's actual contact information. Storage module 132 may store owner contact information and the corresponding identifiers or masking contact information in a contact information database, which may be stored in storage device 128.

Service provider 102 may receive, via network interface 126, a message from a computing device (e.g., computing device 104) that reads the computer-generated image, indicating a message to communicate with owner of property 108 associated with the computer-generated image. The message may include, among other information, the identifier or the masking contact information encoded in the computer-generated image. Contact information module 140 may utilize the identifier to look up the owner contact information in the contact information database in storage module 132. Communication module 142 may then utilize the owner contact information to communication with the owner associated with the identifier or masking contact information using the method of communication indicated as the preference of the owner (e.g., phone call, SMS message, e-mail, etc.)

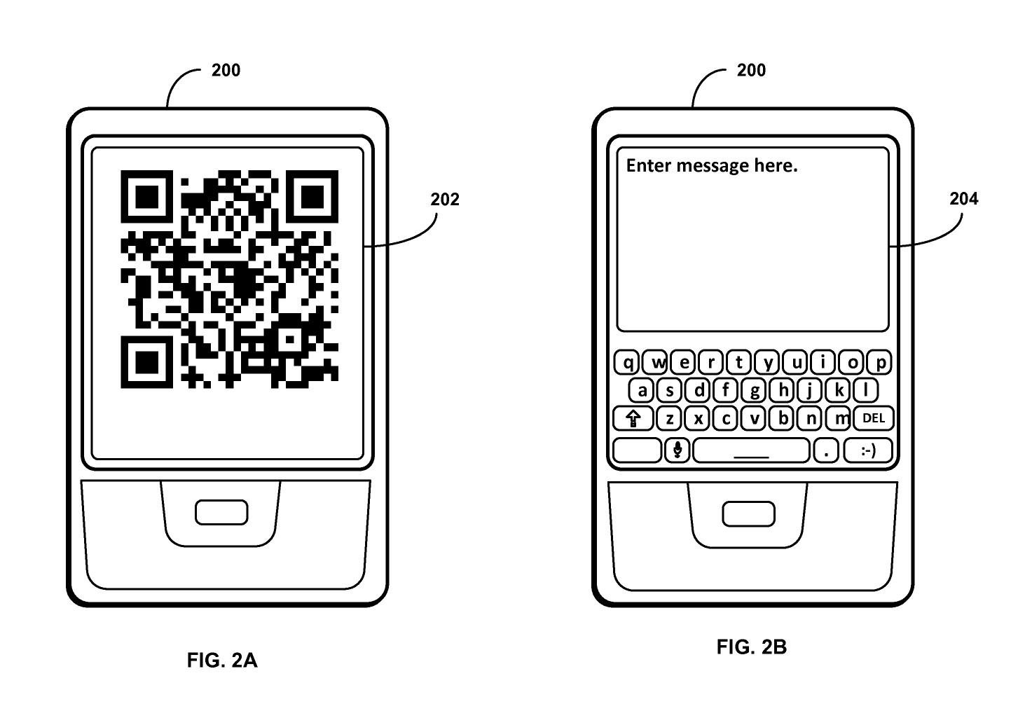

FIGS. 2A and 2B illustrate example screens of a computing device 200 as a user interacts with the device. As discussed above, a property owner may obtain a computer-generated image that encodes information regarding contacting the owner if property is misplaced and subsequently found and scanned by another person. The owner may place the computer-generated image on his/her property. In one example, the owner may misplace his/her property, and a user of a computing device may find the misplaced property. As shown in the example of FIG. 2A, the user may utilize computing device 200 to scan the computer-generated image on the misplaced property. Computing device 200 may be equipped with an image capture device (e.g., camera) that the user may operate to capture an image of the computer-generated image. Computing device 200 may be, for example, a mobile phone, tablet, PDA, or the like, and may have a reader application, which may be built into computing device 200, such as part of an operating system, or added by the user. Computing device 200 may also include screen 202 via which computing device 200 displays to the user application-related options and screens. In one example, screen 202 may be a touch screen that allows interaction by user's touch via user's finger or a device (e.g., stylus pen).

When the user captures the image of the computer-generated image, as shown in FIG. 2A, the captured image may be displayed on display 202. Computing device 200 may employ a processor to execute an algorithm that determines, based on the captured image, that the captured image is of a barcode. The algorithm may subsequently launch the reader application, which is capable of decoding the captured image of the computer-generated image. The reader application may determine, based on the decoded information contained in the computer-generated image, the owner's preferred method of communication as encoded in the computer-generated image. In one example, the reader application may launch the communication application corresponding to the owner's preferred method of communication.

For example, if the owner's preferred method of communication is SMS messaging, reader application may launch the SMS messaging application on computing device 200 and prompt the user to enter an SMS message to the owner, as shown in FIG. 2B. The user may then enter a message on display 204 and send it. In another example, if the owner's preferred method of communication is a telephone call, reader application may prompt the user with a selection to place a call. In this example, the call may go directly to the owner, or for more anonymity, may go through the service provider, which may contact the owner. In this example, the reader application may prompt the user to enter a message that the service provider may communicate to the owner when the service provider contacts the owner. In one example, the call may be forwarded to the owner, such that the user of computing device 200 and the owner can have a live call. In another example, the call by the user of computing device 200 may be recorded and forwarded to the owner as a voice message.

In another example, if the owner's preferred method of communication is e-mail, reader application may launch an e-mail application and prompt the user to write an e-mail message to the owner regarding the misplaced property, or reader application may launch an SMS messaging application and prompt the user to send a message to the service provider, which may forward the message as an e-mail to the owner, or reader application may prompt the user to send an indication, which may prompt the service provide to send an e-mail to the owner regarding the misplaced property.

In one example, the reader application may launch any communication application available in computing device 200 if, for example, the communication application corresponding to the owner's preferred method of communication is not available or desirable to use on computing device 200. For example, the owner's preferred method of communication may be SMS messages, but using SMS on computing device 200 may incur additional cost to its user, who may not wish to use SMS. In one example, the reader application may provide a list of communication applications to the user of computing device 200 with an indication of the owner's preferred method of communication, and the user of computing device 200 may be able to select the communication application preferred by the user of computing device 200.

When the user completes the communication, the reader application may terminate and computing device 200 may resume its normal functions. As shown in the example, computing device 200 does not at any point display to the user the owner's contact information, thereby, maintaining anonymity of owner's contact information.

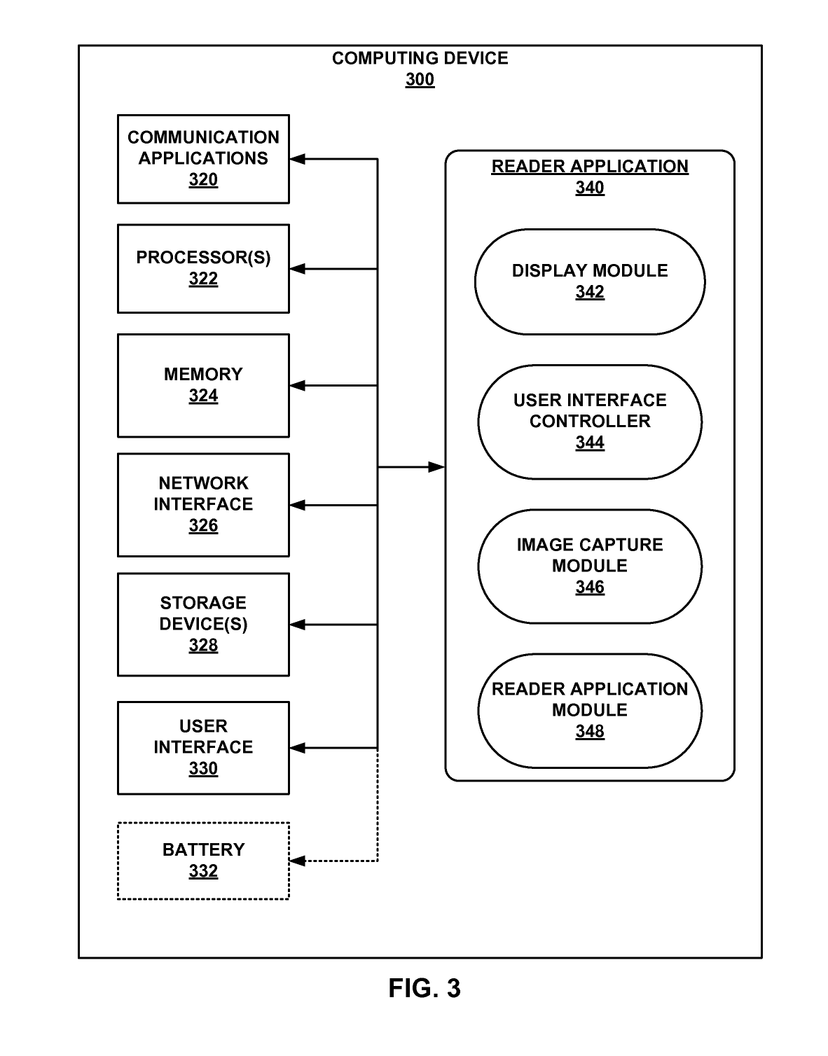

FIG. 3 is a block diagram illustrating further details of one example of the computing device 200 shown in FIGS. 2A and 2B. FIG. 3 illustrates only one particular example of computing device 300, and many other example embodiments of computing device 300 may be used in other instances. As shown in the example of FIG. 3, computing device 300 includes communication applications 320, one or more processors 322, memory 324, a network interface 326, one or more storage devices 328, user interface 330, and an optional battery 332. For example, if computing device 300 comprises a mobile or portable device, computing device 300 may include battery 332. Each of components 322, 324, 326, 328, 330, and 332 may be interconnected via one or more buses for inter-component communications. Processors 322 may be configured to implement functionality and/or process instructions for execution within computing device 300. Processors 322 may be capable of processing instructions stored in memory 324 or instructions stored on storage devices 328.

User interface 330 may include, for example, a monitor or other display device for presentation of visual information to a user of computing device 300. User interface 330 may further include one or more input devices to enable a user to input data, such as a manual keyboard, mouse, touchpad, trackpad, etc. In some example, user interface 330 may comprise a touchscreen, which may be used both to receive and process user input and also to display output information and application-specific options. User interface 330 may further include printers or other devices to output information. In various instances in the description contained herein, references made to user interface 330 may refer to portions of user interface 330 (e.g., keyboard, touch screen, mouse device) that provide user input functionality.

Memory 324 may be configured to store information within computing device 300 during operation. Memory 324 may, in some examples, be described as a computer-readable storage medium. In some examples, memory 324 is a temporary memory, meaning that a primary purpose of memory 324 is not long-term storage. Memory 324 may also be described as a volatile memory, meaning that memory 324 does not maintain stored contents when the computer is turned off. Examples of volatile memories include random access memories (RAM), dynamic random access memories (DRAM), static random access memories (SRAM), and other forms of volatile memories known in the art. In some examples, memory 324 may be used to store program instructions for execution by processors 322. Memory 324 may be used by software or applications running on computing device 300 (e.g., reader application) to temporarily store information during program execution.

Storage devices 328 may also include one or more computer-readable storage media. Storage devices 328 may be configured to store larger amounts of information than memory 324. Storage devices 328 may further be configured for long-term storage of information. In some examples, storage devices 328 may comprise non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Computing device 300 also includes network interface 326. Computing device 300 may utilize network interface 326 to communicate with external devices (e.g., one or more servers, web servers) via one or more networks. Computing device 300 also includes communication applications 320, which may include applications available on computing device 300 that a user of computing device 300 may utilize for communicating. Communication applications 320 may include, for example, voice- and/or text-based application, such as SMS messaging, e-mail, telephone capabilities, and the like.

Any applications implemented within or executed by computing device 300 (e.g., reader application) may be implemented or contained within, operable by, executed by, and/or be operatively coupled to processors 322, memory 324, network interface 326, storage devices 328, and/or user interface 330.

One example of reader application 340 is shown in FIG. 3. Reader application 340 may include a display module 342, a user interface controller 344, an image capture module 346, and a reader application module 348. Reader application 340 may include image capture module 346, which scans in and reads computer-readable or computer-generated images, such as barcodes, as discussed above. Reader application 340 may be stored in memory 324 and/or storage devices 330, and may be operable by processors 322 to perform various tasks during execution.

In one example, during implementation or execution of reader application 340, image capture module 346 may be operable by processors 322 to capture an image. Display module 342 may be also operable by processors 322 to display the image captured by the image capture module. Image capture module 346 may be capable of detecting whether the captured image is a computer-generated image such as, for example, a QR code. Reader application module 348 may be launched by processors 322 if image capture module 346 determines that a captured image is a computer-generated image. Reader application module 348 may be operable by processor 322 to decode an image determined to be a computer-generated image and launch a corresponding communication application 320, e.g., SMS messaging application or e-mail application. Reader application module 348 may decode the computer-generated image to determine the information contained therein, and launch the appropriate application. For example, if the information encoded in the computer-generated image indicates an owner's preference for contact by e-mail, reader application module 348 may launch an e-mail application of computing device 300.

User interface controller 344 may be operable by processors 322 to receive, via user interface 330, user input specifying interacting with a communication application launched by reader application module 348 (e.g., SMS message text or e-mail text). User interface controller 344 may send the appropriate communication message entered by the user via network interface 326, and terminate the reader application 340 upon completion of the communication.

In one example, reader application module 348 may launch any communication application available in computing device 300 if, for example, the communication application corresponding to the owner's preferred method of communication is not available or desirable to use on computing device 300, as discussed above. In another example, reader application module 348 may display a list of communication applications to the user of computing device 300 with an indication of the owner's preferred method of communication. In this example, the user of computing device 300 may be able to select from the list of communication applications an application preferred by the user of computing device 300.

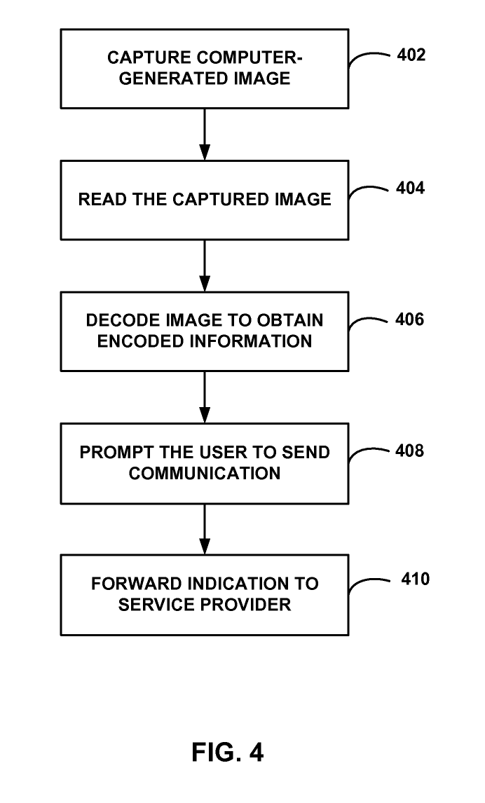

FIG. 4 is a flow diagram illustrating a process for anonymous user notification that may be performed by a computing device. For example, the illustrated example method may be performed by computing device 200 (FIGS. 2A and 2B) or computing device 300 (FIG. 3). In some examples, a computer-readable storage medium (e.g., a medium included in storage device 328 of FIG. 3) may be encoded with instructions that, when executed, cause one or more processors (e.g., processor 322) to perform one or more of the acts illustrated in the method of FIGS. 2A, 2B, and 3.

The method of FIG. 4 includes scanning, by the computer device, a computer-generated image, where the computer-generated image is computer-readable (402). Scanning the computer-generated image may be achieved by capturing the image via an image capture device of the computing device. The computer-generated image may be associated with one or more tangible objects belonging to a user. For example, the computer-generated image may be affixed to a tangible object. A service provider may generate the computer-generated image, by encoding the user's contact information. Encoding the user's contact information may comprise encoding a reference to the contract information. Scanning the computer-generated image may result in obtaining the encoded reference to the contact information.

The method further includes reading the scanned image by a reader application running on the computing device (404). The reader application may read the captured image by decoding the image to obtain the encoded information (e.g., the reference to the contact information) (406). The obtained information may be contact information associated with the user, where the user's contact information is not available for display on the computing device that scans the computer-readable image. In one example, the obtained information or reference may be an identifier associated with the user, which when communicated to the service provider may be utilized to locate the user's contact information and a preferred method of communication.

The method also includes a prompt to send a communication to the user (i.e., the owner of the tangible object) (408). As described above, the method of communication may depend on the user's preference. For example, the preference may be to be contacted via text message or e-mail. In this example, the reader application may launch the application, SMS messaging or e-mail application, for the user of the computing device to enter text. In another example, the preference may be to be contacted via phone, and the reader application may launch the phone application for the user of the computing device to place a phone call. The user of the computing device may have no access to the actual contact information associated with the user who is the owner of the tangible objects. In one example, the communication from the computing device may be forwarded as an indication to the service provider with the encoded information, which serves as an indication of the corresponding contact information of the user or owner of the tangible objects (410). The service provider may subsequently transmit a message to the user regarding the misplaced property.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various embodiments of the disclosure have been described. These and other embodiments are within the scope of the following claims.

1-17. (canceled)

18. A method comprising:
scanning, by a computing device, a computer-readable image associated with one or more tangible objects, to obtain encoded information, wherein the information comprises a reference to contact information associated with a user, and wherein the contact information associated with the user is unavailable to the computing device;
decoding the encoded information to obtain the reference; and
transmitting, from the computing device to a service provider, an indication of the reference, an indication of the one or more tangible objects, and an indication of the computing device, such that the service provider is capable of using the contact information to communicate with the user regarding the one or more tangible objects.

19. The method of claim 18, wherein the reference comprises information that identifies the user.

20. The method of claim 19, wherein the information comprises a communication preference comprising text-based communication, the method further comprising transmitting to the user a text-based application message associated with the one or more tangible objects via the service provider.

21. The method of claim 19, wherein the information comprises a communication preference comprising voice-based communication, the method further comprising transmitting to the user a voice-based application message associated with the one or more tangible objects via the service provider.

22. The method of claim 18, further comprising launching a communication application on the computing device in response to reading the computer-readable image to transmit to the service provider the indication of the reference, the indication of the one or more tangible objects, and the indication of the computing device.

23. The method of claim 22, further comprising transmitting a communication corresponding to the communication application.

24. The method of claim 23, further comprising receiving, from the service provider or the user, communication associated with the one or more tangible objects in response to transmitting the communication.

25. A computer-readable storage medium encoded with instructions that, when executed, cause one or more processors of a computing device to perform operations comprising:
scanning, by computing device, a computer-readable image associated with one or more tangible objects, to obtain encoded information, wherein the information comprises a reference to contact information associated with a user, and wherein the contact information associated with the user is unavailable to the computing device;
decoding the encoded information to obtain the reference; and
transmitting, from the computing device to a service provider, an indication of the reference, an indication of the one or more tangible objects, and an indication of the computing device, such that the service provider is capable of using the contact information to communicate with the user regarding the one or more tangible objects.

26. A computing device, comprising:
a scanning device operable to scan a computer-readable image associated with one or more tangible objects, to obtain encoded information, wherein the information comprises a reference to contact information associated with a user, and wherein the contact information associated with the user is unavailable to the computing device;
one or more processors operable to decode the encoded information to obtain the reference; and
a transmitter operable to transmit, to a service provider, an indication of the reference to the contact information, an indication of the one or more tangible objects, and an indication of the computing device, such that the service provider is capable of using the contact information to communicate with the user regarding the one or more tangible objects.

27. A method comprising:
receiving from a first computing device, by a service provider, an indication of a reference to contact information associated with a user of a second computing device, an indication of the first computing device, and an indication of one or more tangible objects, wherein the reference is encoded in a computer-readable image associated with the one or more tangible objects;
determining the contact information associated with the user based on the reference; and
using the contact information to transmit a communication regarding the one or more tangible objects to the second computing device.

28. The method of claim 27, wherein the service provider comprises a database comprising contact information associated with a plurality of users, wherein contact information associated with each of the plurality of the users corresponds to a unique reference.

29. The method of claim 27, further comprising determining a communication preference of the user based on the reference.

30. The method of claim 29, wherein the communication preference comprises text-based communication, the method further comprising transmitting a text-based application message associated with the one or more tangible objects to the second computing device using the contact information.

31. The method of claim 30, further comprising receiving the text-based application message from the first computing device.

32. The method of claim 29, wherein the communication preference comprises voice-based communication, the method further comprising transmitting a voice-based application message associated with the one or more tangible objects to the second computing device using the contact information.

33. The method of claim 32, further comprising receiving the voice-based application message from the first computing device.

34. The method of claim 29, further comprising transmitting the communication preference to the first computing device.

35. A computer-readable storage medium encoded with instructions that, when executed, cause one or more processors of a service provider device to:
receive, from a first computing device, an indication of a reference to contact information associated with a user of a second computing device, an indication of the first computing device, and an indication of one or more tangible objects, wherein the reference is encoded in a computer-readable image associated with the one or more tangible objects;
determine the contact information associated with the user based at least in part on the reference; and
use the contact information to transmit a communication regarding the one or more tangible objects to the second computing device.

36. A service provider device comprising:
a network interface configured to receive, from a first computing device, an indication of a reference to contact information associated with a user of a second computing device, an indication of the first computing device, and an indication of one or more tangible objects, wherein the reference is encoded in a computer-readable image associated with the one or more tangible objects;
one or more programmable processors configured to:
determine the contact information associated with the user based at least in part on the reference; and
use the contact information to transmit a communication regarding the one or more tangible objects to the second computing device.

37. The service provider device of claim 36, further comprising:
at least one storage device configured to store a database comprising contact information associated with a plurality of users, wherein contact information associated with each of the plurality of the users corresponds to a unique reference.
